(19) United States
(12) Patent Application Publication
(10) Pub. No.: US 2007/0145188 A1
(43) Pub. Date: Jun. 28, 2007

(54) Component, particularly a lightweight hybrid component

(75) Inventor: Gregor Specht, Stuttgart (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/579,905

(22) PCT Filed: Nov. 19, 2004
(86) PCT No.: PCT/EP04/13185

§ 371 Date: May 19, 2006

(30) Foreign Application Priority Data
Nov. 19, 2003 (DE) 10354120.9

(51) Int. Cl. B64B 1/02

(52) U.S. Cl. 244/125

(57) ABSTRACT

The invention relates to a component (1) comprising a particularly shell-shaped base carrier (2) and at least one core element (6). The aim of the invention is to provide an improved component (1), wherein an intermediate layer (5) is inserted in between the base carrier (2) and the core element (6) in order to compensate tolerances, resulting in a positive power flow via the intermediate layer (4) and improved tolerance compensation.

The invention relates to a component, particularly a hybrid component with a shell-shaped basic member and at least one core element.

Components of this type, for example a tubular member or cross member, are used in vehicle construction, but also in a corresponding configuration in aircraft construction. A cross member comprising a tube for example is usually produced exclusively from metal on account of the better modulus of elasticity, a basic body that is for example deep-drawn from steel sheet or aluminum sheet being welded, riveted or bolted to reinforcing ribs. The component has correspondingly great wall thicknesses, in order that there is adequate bending, buckling and torsional rigidity and it can adequately withstand compressive loading. This results in a high weight and cost disadvantages. The component can be used in principle for air ducting, for example for an air-conditioning system. This involves the problem that undesired condensation can easily form on the metal tubes.

There is also a known component which has a two-shell construction with welded-in webs for stabilization. A component of this type is known for example from DE 197 20 902. The component is very complex to produce and has a high weight.

EP 0 370 342 discloses a lightweight component of a hybrid type of construction that can be used as a member in a motor vehicle and has a shell-shaped basic body, preferably consisting of metal, in the interior space of which reinforcing ribs are arranged. The reinforcing ribs consist of injection-molded plastic and are connected to the basic metal body at discrete connecting points, in that the plastic passes through apertures arranged in the metal part and reaches over the surfaces of the apertures. The basic metal body is formed in a U-shaped manner, and the reinforcing ribs pass through the interior space of the basic body to achieve high rigidity and strength. This known hybrid component has an advantageously low weight with, at the same time, adequate strength, rigidity and load-bearing capacity.

DE 200 08 201 U discloses a cross member of a hybrid type of construction with a shell-like basic body which is stiffened by injection-molded plastic ribbing. The plastic ribs are formed in such a way that a plastic tube serving as an air duct can be put in place with positive engagement. Introducing a duct in such a way is a complex operation, since the duct has to be separately produced and put in place in one working step. The ribs that are adapted in their shape in such a way lose stability.

Starting from this prior art, the invention is based on the object of providing a lightweight component and a method for its production which has improved properties and is inexpensive.

The object is achieved according to the invention by a component, comprising a shell-shaped basic member and at least one core element, the basic member having at least one closing seam and being connected to the core element by means of at least one tolerance-compensating intermediate layer.

Furthermore, the invention relates to a method for producing a component according to the invention, in which the tolerance-compensating intermediate layer is introduced onto the inner side of the non-closed basic member and at least one core element is applied to the intermediate layer and the basic member is closed and permanently connected along one or more closing seams by means of a suitable joining technique.

The invention also relates to the use of the component according to the invention in vehicles or aircraft.

Advantageous developments are the subject of the subclaims.

The invention is based on the idea of providing an expensive, stable lightweight component which has a high modulus of elasticity and at the same time a low weight and a low thermal conductivity. For this purpose, the component comprises a stable shell-shaped basic member, for example made of metal, and a core element, for example made of plastic. The inner side of the basic member and the core element are connected by means of at least one tolerance-compensating intermediate layer.

Numerous combinations of materials and surfaces are possible for the component. This leads to great flexibility in the production of the component and to great flexibility in its possibilities for use.

Furthermore, integral connection of the metallic basic member and the core element by adhesion is possible by means of the production method. The tolerance compensation is preferably achieved by intermediate layers such as adhesive. The production method and the component produced by it permit simple modeling of the composite system in the component by a uniform stress distribution in adhesive intermediate layers. The component also has a high moment of surface resistance, since a closed basic metal member that is as thin as possible surrounds the core elements. The basic member is not restricted in this case to a straight basic member, but may also assume a shape in plan view as can occur for example in floor assemblies or sheet-like stiffening parts of vehicles or aircraft.

Furthermore, the component leads to a space saving, since guiding elements such as air-guiding elements or lines can be routed in the basic member, for example in cavities formed through the basic member. A special structure of the basic member, such as clearances in the form of holes in the basic member, allows core elements to penetrate to the outside, whereby mechanical integrations such as the bolting on of an airbag are made possible for example. The special composite structure of the component and the type of production also allow rapid and inexpensive prototype generation, which is of great significance specifically in vehicle manufacture. Among the reasons allowing this to be achieved are the low tool costs and tool changing costs, since a modular construction with core elements can be chosen. This results in flexible solutions, such as for example for left and right halves, which in turn make small injection molds or forming tools possible.

The core elements may also perform tasks such as conducting and insulating air streams, integrating components located outside the basic metal member, and/or stiffening the structure by means of metal reinforcements.

For the purposes of the invention, shell-shaped basic metal members are to be understood as meaning, in particular, one-part or multi-part basic members made of metal or metal compositions with a high modulus of elasticity. The component, i.e. the composite element, preferably comprises a basic member made of steel. The basic metal member may have a special surface with different structures or placed-on materials, for example a surface with holes. Through the holes in the basic member, the core elements can penetrate to the outside, whereby integrations are made possible. For the purposes of the invention, integrations are to be understood as meaning, for example, mechanical integrations. Mechanical integrations, for example airbags and/or a steering column, are particularly suitable.

In a further refinement, at least one core element is arranged with the basic member in a composite assembly in the component. The core element may preferably be a functional component made of plastic or metal, such as steel. The core element is preferably a plastic element. The plastic has a low weight and a low thermal conductivity. The core element may be a one-part or multi-part element. The core elements can preferably perform tasks such as conducting and insulating air streams, integrating components located outside the basic metal member or stiffening the structure by means of metal reinforcements in the core elements. Apart from the core element, the component may additionally contain electrical lines, interconnects, fiber-optic cables, sensors, strain gages and/or electronic chips.

Furthermore, the basic member has at least one closing seam. The closing seam may enclose to the greatest extent the space formed by the basic metal member and the core elements. A short interruption of the closing seam may be possible without any disadvantages, in particular at locations where there is little stress, in order for example to lead a cable harness from the inside to the outside or vice versa.

The closing seam preferably has at least one joining location. The basic member is preferably closed by means of the closing seam by a suitable joining technique. With particular preference, the basic member is closed by means of the closing seam by welding, soldering, adhesive bonding, double-bend joining, bolting and/or riveting. In a further embodiment, the basic member is closed by a combination of adhesive bonding and double-bend joining.

Preferably, the closing seam has, in particular during the welding, soldering, double-bend joining or adhesive bonding, a thickness corresponding to the thickness of the closed basic member. In the joining method, such as riveting or bolting, the thickness of the closing seam should preferably not exceed ten times the thickness of the closed basic member.

The connection of the basic member to the core elements takes place for the most part by means of tolerance-compensating intermediate layers. For the purposes of the invention, tolerance-compensating intermediate layers are to be understood as meaning with preference intermediate layers which comprise adhesives and sealants, double-sided adhesive tape and/or sealing or foam strips. Particularly suitable tolerance-compensating intermediate layers are, for example, polyurethane adhesives.

The component is not restricted to a straight basic member, but may also assume another shape in plan view. For the purposes of the invention, other shapes may be shapes such as occur for example in floor assemblies or sheet-like stiffening parts of vehicles or aircraft.

In the method for producing the component, at the beginning the tolerance-compensating intermediate layer is introduced onto the inner side of a non-closed basic member and at least one core element is applied to the intermediate layer. The open basic member is then closed and permanently connected along one or more closing seams by means of a suitable joining technique. Optionally, electrical lines, interconnects, fiber-optic cables, sensors, strain gages and/or electronic chips for example may be additionally put in place or adhesively fixed at the same time.

The method for producing the component is made up of the following method steps:
I) the presence of one or more basic members, which are not closed,
II) introduction of at least one tolerance-compensating intermediate layer,
III) introduction of at least one core element and/or optionally other elements, such as for example electrical lines, interconnects, fiber-optic cables, sensors, strain gages and/or electronic chips,
IV) closing of the open basic member,
V) permanent connection of the closed basic member along one or more closing seams by means of a suitable joining technique.

The component may be used in any technical areas. With particular preference, the component is used in vehicle and aircraft construction. As a support for an instrument panel, for example, the component may include mounts and air ducts and also part of the air-conditioning system.

Exemplary embodiments of the invention are explained in more detail on the basis of a drawing, in which:

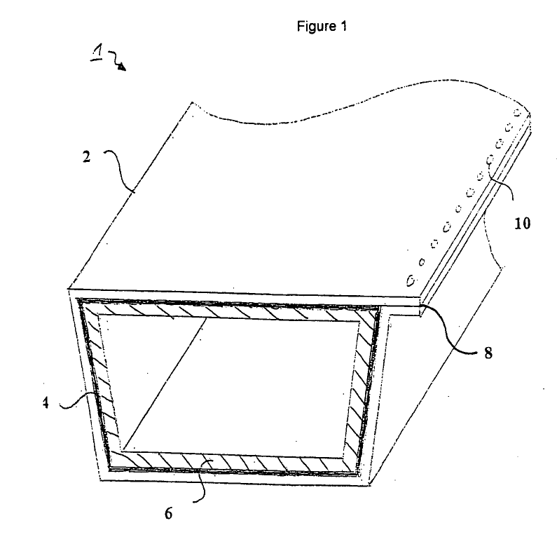

FIG. 1 shows a perspective representation of the component with a closing seam,

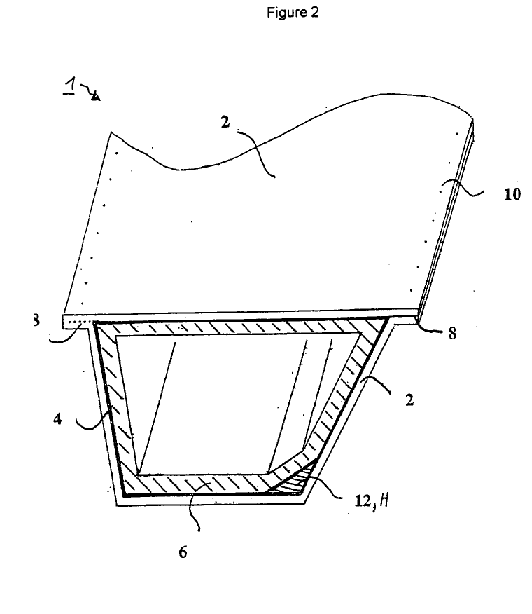

FIG. 2 shows a plan view of a component with two closing seams,

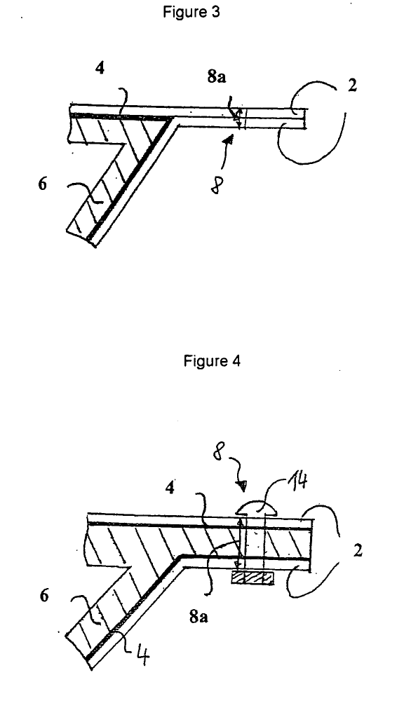

FIG. 3 shows a view of a detail of a closing seam of a component,

FIG. 4 shows a view of a detail of a closing seam with double-bend connection,

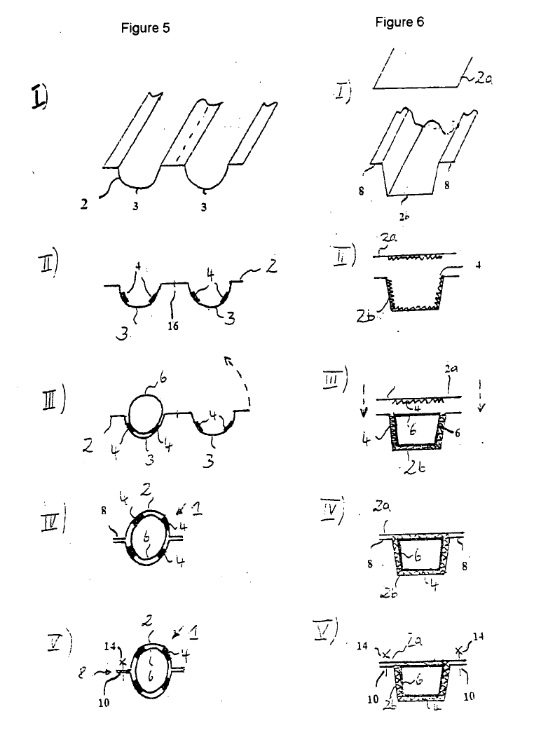

FIGS. 5 I) to 5 V) schematically show the sequence of a method for producing a component with a basic member and a closing seam,

FIGS. 6 I) to 6 V) schematically show the sequence of a method for producing a component with two basic members and two closing seams.

The invention is explained in detail below on the basis of exemplary embodiments with reference to the drawings. Parts which correspond to one another are provided with the same designations in all the figures.

FIG. 1 shows a rectangular exemplary embodiment of a component 1, for example a cross member for a vehicle or aircraft. The component 1 comprises a basic member 2. On the inner side of the basic member 2, a core element 6 is introduced with a tolerance-compensating intermediate layer 4 interposed. A metallic body or a metallic profile, in particular a shell-shaped metal profile, serves for example as the basic member 2. For the component 1 to be of a lightweight construction, the core element 6 is made of plastic. A layer of adhesive is preferably provided as the intermediate layer 4. Alternatively, the intermediate layer 4 may be formed as a double-sided adhesive tape and/or sealing or foam strip. In other words, the basic member 2 is connected to the core element 6 by means of the intermediate layer 4. The basic member 2 may be additionally permanently connected along a closing seam 8 by means of joining locations 10.

FIG. 2 shows a multipart component 1. In this exemplary embodiment, the basic member 2 comprises two closing seams 8, which have a number of joining locations 10 for permanent connection. In addition to the plastic insert part or core element 6, further elements 12, such as for example electrical lines, are introduced into the component 1, in particular in a cavity H formed between the core element 6 and the basic member 2.

FIGS. 3 and 4 show views of details of a closing seam 8 of the component 1. In FIG. 3, the basic member 2 is closed by means of the closing seam 8 by welding. The thickness 8a of the closing seam 8 corresponds to the thickness of the connected basic member 2 at this location. In FIG. 4, the basic member 2 is closed by means of the closing seam 8 by a bolt 14. In this case, the basic member 2 is formed as a two-part member, so that the two elements of the basic member 2 are connected to each other in the region of the closing seam 8 with the intermediate layer 4 and the core element 6 interposed. Consequently, in this exemplary embodiment, the thickness 8a of the closing seam 8 corresponds to the thickness of the two elements, for example two half-shells, of the basic member 2, the thickness of the intermediate layers 4 and the thickness of the core element 6.

FIGS. 5 I) to V) show the sequence of a method for producing a component 1, for example a tubular member, with a one-part basic member 2. Adhesive and/or a double-sided adhesive tape and/or a sealing or foam strip is introduced into both half-shells 3 of the basic member 2 as an intermediate layer 4. The core element 6 is applied to the intermediate layer 4 in one of the two half-shells 3 and the basic member 2 is closed by means of a bending location 16. The basic member 2 is permanently connected by means of the closing seam 8 at the joining location 10 by a bolt 14. Depending on the type and shape of the intermediate layer 4, the adhesive can be distributed in the cavity H, formed between the core element 6 and the basic member 2, by mechanical loading when the basic member 2 is closed, so that a peripheral intermediate layer 4 is formed.

FIGS. 6 I) to 6 V) schematically show the sequence of a method for producing a component 1 with a two-part basic member 2. For example, the basic member 2 comprises two elements 2a and 2b, for example a half-open profile and a cover. Alternatively, the basic member 2 may be formed from two half-shells or two other half-profiles. In the case of a two-part embodiment of the basic member 2, it has two closing seams 8 for permanent connection. Adhesive, a double-sided adhesive tape and/or a sealing or foam strip is introduced on the inner sides of the elements 2a, 2b of the basic member 2 as a tolerance-compensating intermediate layer 4. The core element 6 is applied to the intermediate layer 4 of one element 2b of the basic member 2. Then, the other element 2a of the basic member 2 is applied to the element 2b and the core element 6 inserted in the latter, and both elements 2a, 2b of the basic member 2 are permanently connected by means of the closing seams 8 by bolts 14 at the joining locations 10.

### LIST OF DESIGNATIONS

1 component
2 basic member
2a,2b elements of a basic member
3 half-shell of a basic member
4 intermediate layer
6 core element
8 closing seam
8a thickness of the closing seam
10 joining location
12 elements
14 bolt
16 bending location

1. A component, comprising a shell-shaped basic member and at least one core element, the basic member having at least one closing seam and being connected to the core element by means of at least one tolerance-compensating intermediate layer.

2. The component as claimed in claim 1, wherein the basic member is formed in a one-part or multi-part manner.

3. The component as claimed in claim 1, wherein the closing seam has at least one joining location.

4. The component as claimed in claim 1, wherein the basic member is closed by means of the closing seam by a joining method, in particular welding, soldering, adhesive bonding, double-bend joining and/or riveting.

5. The component as claimed in claim 1, wherein the closing seam has during the welding, soldering, double-bend joining or adhesive bonding and/or after the joining, a thickness corresponding to the thickness of the closed basic member.

6. The component as claimed in claim 1, wherein the thickness of the closing seam after the joining is at most ten times the thickness of the closed basic member.

7. The component as claimed in claim 1, wherein the basic member has clearances, in particular is formed in such a way that it is partially perforated.

8. The component as claimed in claim 7, wherein integrations are provided, in particular at the joining locations.

9. The component as claimed in claim 1, wherein the core element is a plastic element.

10. The component as claimed in claim 1, wherein the tolerance-compensating intermediate layer comprises an adhesive and/or sealant, a double-sided adhesive tape and/or sealing or foam strips.

11. The component as claimed in claim 1, wherein electrical lines, interconnects, fiber-optic cables, sensors, strain gages and/or electronic chips are additionally provided as elements.

12. A method for producing a component as claimed in claim 1, in which a tolerance-compensating intermediate layer is introduced onto the inner side of the cross-sectionally open basic member and at least one core element is applied to the intermediate layer and the basic member is closed and permanently connected along one or more closing seams by means of a suitable joining technique.

13. The method as claimed in claim 12, wherein elements such as electrical lines, interconnects, fibre-optic cables, sensors, strain gages and/or electronic chips are additionally introduced.

14. The use of a component as claimed in claim 1 in vehicles or aircraft.
